(19) United States
(12) Patent Application Publication
(10) Pub. No.: US 2012/0086321 A1
(43) Pub. Date: Apr. 12, 2012

(54) ROTATABLE HEAT DISSIPATING DEVICE

(76) Inventors: Wen-Ji Lan, Sinjhuang City (TW); Wei-Shan Deng, Sinjhuang City (TW)

(21) Appl. No.: 12/902,905

(22) Filed: Oct. 12, 2010

(51) Int. Cl. H01J 61/52; F28D 15/04; F28F 7/00

(52) U.S. Cl. 313/45; 165/185; 165/104.26

(57) ABSTRACT

A rotatable heat dissipating device includes a heat-transfer element and a heat-dissipation element. The heat-transfer element includes a flat main body, a heat transfer section extended from one face of the main body. The heat-dissipation element includes base having a recess provided on one face oriented toward the main body, a heat radiating section, and a connecting section extended between the base and the radiating section. The main body is rotatably received in and connected to the recess of the base, enabling the rotatable heat dissipating device to flexibly connect to a heat-producing unit in different directions without the need of using any external adaptor. Therefore, the rotatable heat dissipating device provides upgraded heat dissipation efficiency and can avoid thermal resistance due to too many adaptors between different elements.

### FIELD OF THE INVENTION

The present invention relates to a rotatable heat dissipating device, and more particularly to a rotatable heat dissipating device having a heat-transfer element and a heat-dissipation element rotatably connected to each other to avoid assembly interference.

### BACKGROUND OF THE INVENTION

A light-emitting-diode (LED) lamp has high brightness and low power consumption, and is therefore the first choice among people to effectuate energy-saving in their daily life. The LED lamp has now be widely applied in warning signs as well as various indoor and outdoor lamps to meet the target of energy saving and carbon reduction.

However, since a high-brightness LED lamp would also produce a large amount of heat during the operation thereof to cause foggy headlight lens and reflector. To solve the problem about the heat dissipation of an LED lamp, different heat dissipating devices and thermal modules, such as heat sinks and radiating fin assemblies, are usually used to remove the heat produced by the high-brightness LED lamp, so as to lower the temperature in the LED lamp and avoid the occurrence of foggy headlight lens and reflector.

Currently, most of the available thermal modules are fixedly assembled and therefore fail to satisfy the requirement for dissipating heat in different directions. For example, the enclosure, the heat sink, and the light-emitting element for the LED lamp are mainly assembled to one another via fastening screws. While the enclosure, the heat sink, and the light-emitting element for the LED lamp can be securely assembled to one another via fastening screws, no flexible change in position is allowed for the assembled parts. In the event the heat sink and other elements must be assembled at specific angle or in different directions, a particularly designed thermal module must be selected for use, so as to match the lamp housing or the light-emitting element. By doing this, it would inevitably result in confusion in the application of the heat dissipating device and increased manufacturing cost thereof.

It has been tried by some manufacturers to bend some heat pipes for use with specific lamp housing and light-emitting elements to dissipate the heat produced by the light-emitting elements. However, the heat pipe allows only a very limited angle of bending to avoid damaging the capillary structure in the heat pipe and lowered heat transfer performance of the heat pipe, which would no doubt have adverse influence on the overall heat dissipation efficiency of the LED lamp.

In brief, the conventional heat dissipating device has the following disadvantages: (1) requiring higher manufacturing cost; (2) having low adaptability to the LED lamp housing and light-emitting elements; and (3) tending to cause assembly interference.

### SUMMARY OF THE INVENTION

A primary object of the present invention is to provide a rotatable heat dissipating device that allows multi-directional connection of a heat-transfer section thereof to a heat source and accordingly, enables upgraded heat transfer and heat dissipation efficiency.

Another object of the present invention is to provide a rotatable heat dissipating device that is able to avoid assembly interference.

To achieve the above and other objects, the rotatable heat dissipating device includes a heat-transfer element and a heat-dissipation element. The heat-transfer element includes a flat main body, a heat transfer section extended from one face of the main body. The heat-dissipation element includes base, a heat radiating section, and a connecting section extended between the base and the radiating section. The heat-dissipation element is provided on one face oriented toward the main body with a recess, such that the main body is rotatably received in and connected to the recess of the base. With the heat-transfer element and the heat-dissipation element being rotatable connected to each other, the rotatable heat dissipating device can be flexibly connected to a heat-producing unit in different directions without the need of using any external adaptor. Therefore, the rotatable heat dissipating device not only allows multi-directional connection of the heat-transfer section thereof to a heat source, but also avoids thermal resistance possibly caused by too many adaptors between different elements.

In brief, the rotatable heat dissipating device according to the present invention has the following advantages: (1) requiring lower manufacturing cost; (2) providing higher flexibility in assembling to different elements, such as the LED lamp housing and light-emitting elements; and (3) capable of avoiding assembly interference.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is an exploded perspective view of a rotatable heat dissipating device according to a first and preferred embodiment of the present invention;

FIG. 2 is an assembled view of FIG. 1;

FIG. 3 is an assembled sectioned side view of FIG. 2;

FIG. 4 is an exploded perspective view of a rotatable heat dissipating device according to a second embodiment of the present invention;

FIG. 5 is an assembled view of FIG. 4;

FIG. 6 is an assembled sectioned side view of FIG. 5;

FIG. 7 is an exploded perspective view of a rotatable heat dissipating device according to a third embodiment of the present invention;

FIG. 8 is an assembled view of FIG. 7; and

FIG. 9 illustrates how the rotatable heat dissipating device of the present invention works.

### DETAILED DESCRIPTION OF THE PREFERRED EMBODIMENTS

The present invention will now be described with some preferred embodiments thereof and with reference to the accompanying drawings. For the purpose of easy to understand, elements that are the same in the preferred embodiments are denoted by the same reference numerals.

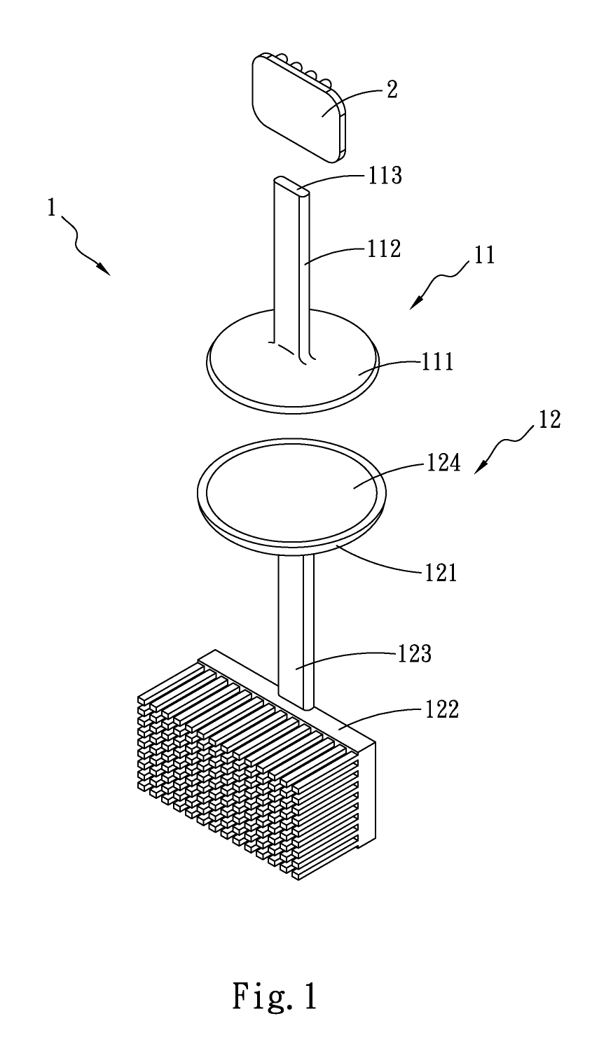

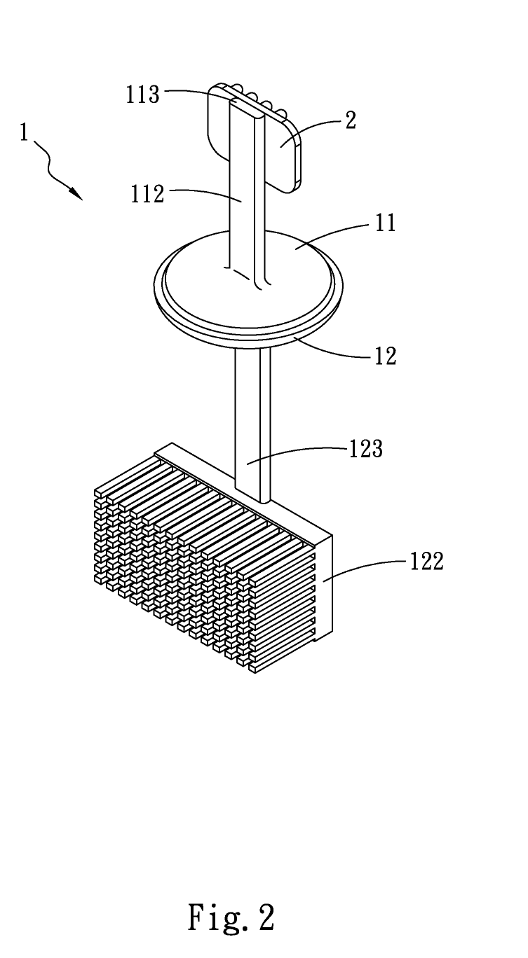

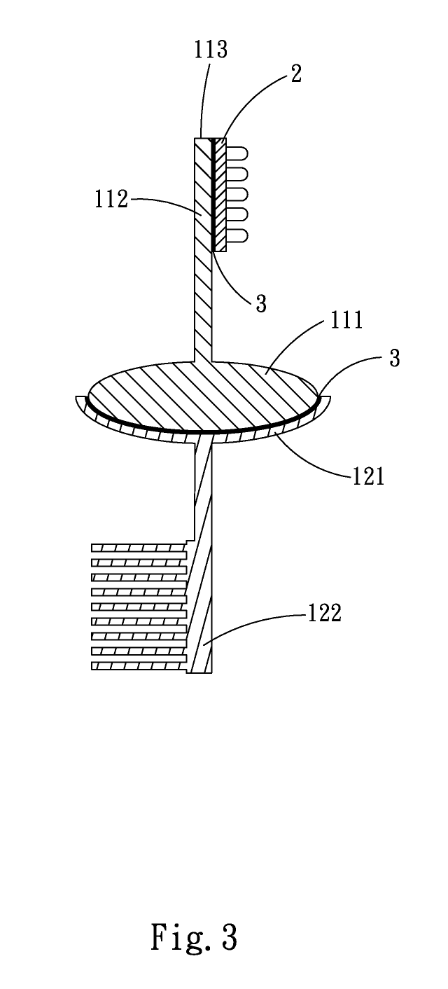

Please refer to FIGS. 1 and 2 that are exploded and assembled perspective views, respectively, of a rotatable heat dissipating device 1 according to a first and preferred embodiment of the present invention, and to FIG. 3 that is an assembled sectioned side view of FIG. 2. As shown, the rotatable heat dissipating device 1 in the first embodiment includes a heat-transfer element 11 and a heat-dissipation element 12.

The heat-transfer element 11 includes a flat main body 111 and a heat transfer section 112 extended from one face of the flat main body 111. In the illustrated first embodiment, the flat main body 111 is in the form of a round plate. However, it is understood the main body 111 is not necessarily limited to the form of a round plate but can be other suitable shapes.

The heat-dissipation element 12 includes a base 121, a heat radiating section 122, and a connecting section 123. The base 121 is provided on one face oriented toward the main body 111 with a recess 124. In the illustrated first embodiment, the recess 124 is a round recess, such that the main body 111 in the form of a round plate is rotatably received in and connected to the round recess 124. The connecting section 123 is extended from one face of the base 121 opposite to the recess 124 to connect with the heat radiating section 122.

The heat-transfer element 11 further includes a heat absorbing end 113 provided on the heat transfer section 112 at an end opposite to the main body 111 for connecting to at least one heat-producing unit 2.

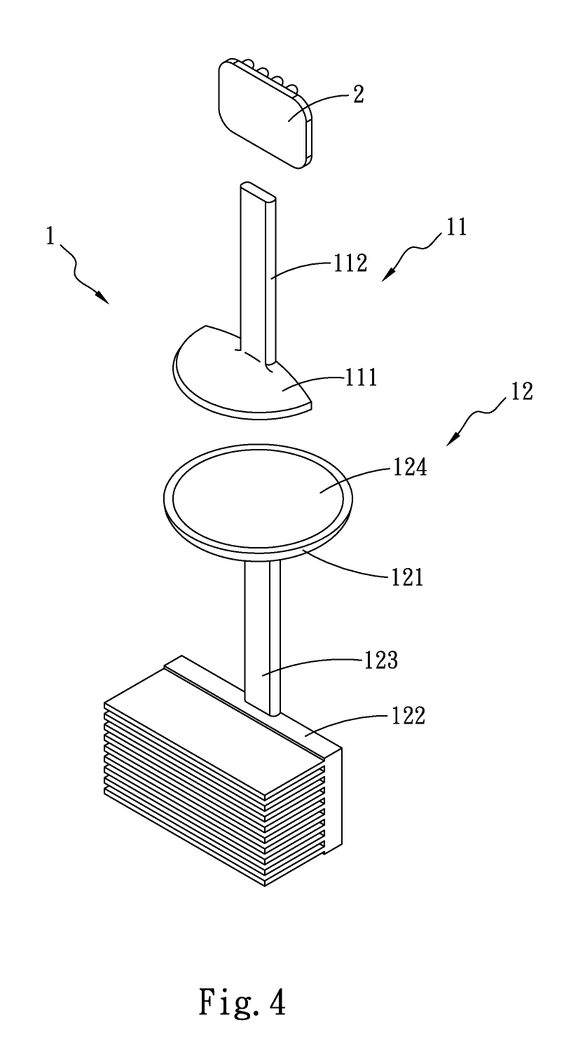

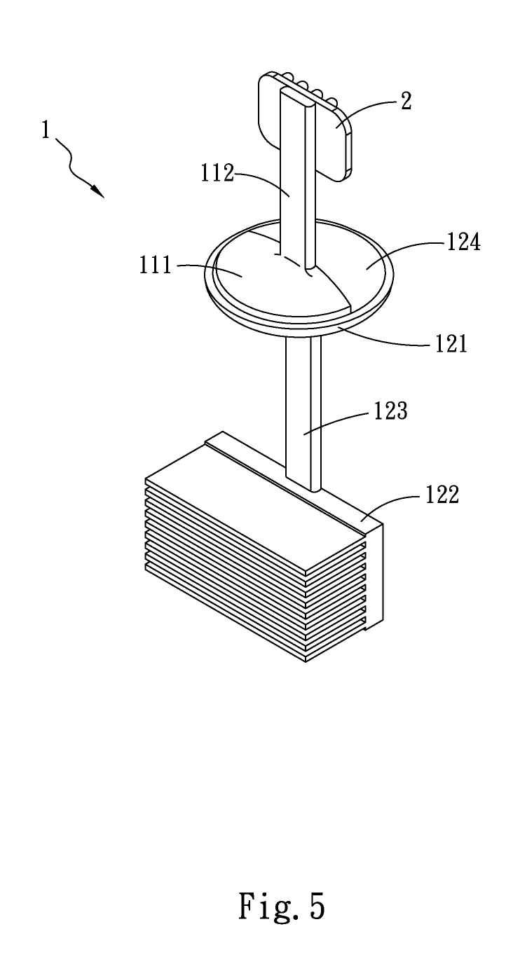

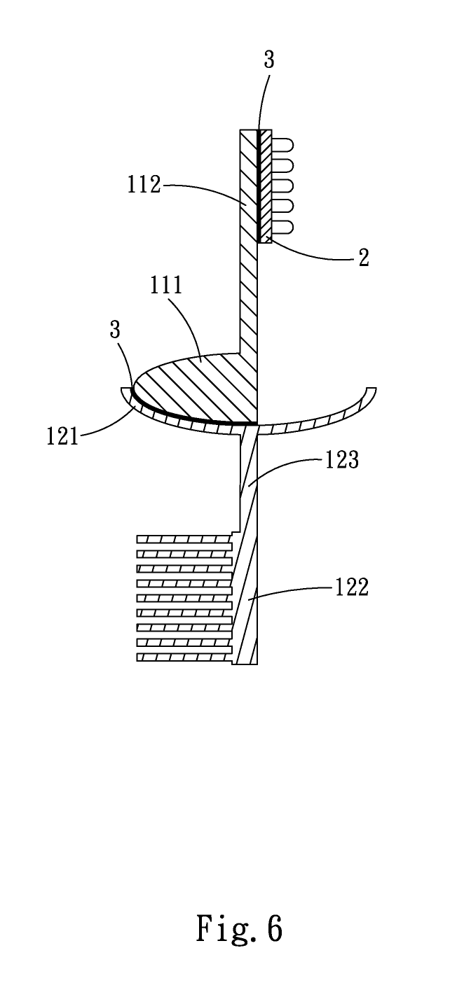

Please refer to FIGS. 4 and 5 that are exploded and assembled perspective views, respectively, of a rotatable heat dissipating device 1 according to a second embodiment of the present invention, and to FIG. 6 that is an assembled sectioned side view of FIG. 5. As shown, the rotatable heat dissipating device 1 in the second embodiment includes a heat-transfer element 11 and a heat-dissipation element 12.

Since the rotatable heat dissipating device 1 in the second embodiment is generally structurally similar to the first embodiment, elements that are the same in the two embodiments are not repeatedly described herein. The second embodiment is different from the first embodiment mainly in that the main body 111 of the heat-transfer element 11 is a semicircular plate without being limited thereto, and the recess 124 on the base 121 of the heat-dissipation element 12 facing toward the main body 111 is a round recess without being limited thereto, such that the semicircular main body 111 is rotatably received in and connected to the round recess 124.

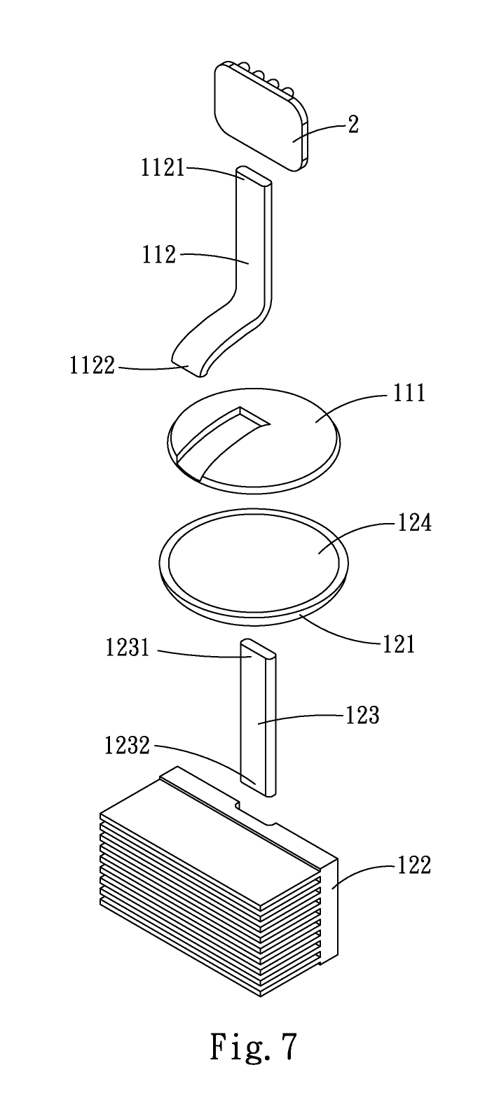

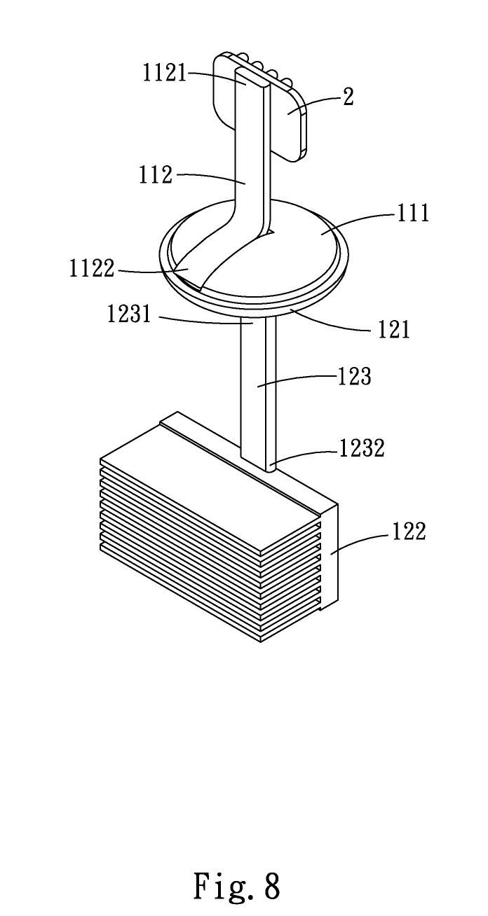

Please refer to FIGS. 7 and 8 that are exploded and assembled perspective views, respectively, of a rotatable heat dissipating device 1 according to a third embodiment of the present invention. Since the rotatable heat dissipating device 1 in the third embodiment is generally structurally similar to the previous embodiments, elements that are the same in the three embodiments are not repeatedly described herein. The third embodiment is different from the previous embodiments mainly in that the heat transfer section 112 of the heat-transfer element 11 is a heat pipe having at least one first heat transfer end 1121 and at least one second heat transfer end 1122. The first heat transfer end 1121 is in contact with at least one heat-producing unit 2, and the second heat transfer end 1122 is connected to the main body 111.

In the third embodiment of the present invention, the connecting section 123 is a heat pipe having at least one third heat transfer end 1231 and at least one fourth heat transfer end 1232. The third heat transfer end 1231 is connected to the base 121, and the fourth heat transfer end 1232 is connected to the heat radiating section 122.

Please refer to FIGS. 1 to 8. The heat radiating section 122 of the rotatable heat dissipating device 1 can be differently structured. In the first embodiment of the present invention, the heat radiating section 122 includes a plurality of pin fins, as shown in FIGS. 1 and 2; and, in the second and third embodiments of the present invention, the heat radiating section 122 includes a plurality of straight fins, as shown in FIGS. 4 and 5 as well as FIGS. 7 and 8.

In the rotatable heat dissipating device 1 of the present invention, a heat conducting medium 3 is applied between the heat-producing unit 2 and the first heat transfer end 1121 or the heat absorbing end 113. The heat conducting medium 3 is also applied between the main body 111 and the recess 124 of the base 121. The heat conducting medium 3 can be any one of a solder paste and a thermal paste.

The heat-producing unit 2 is an LED module.

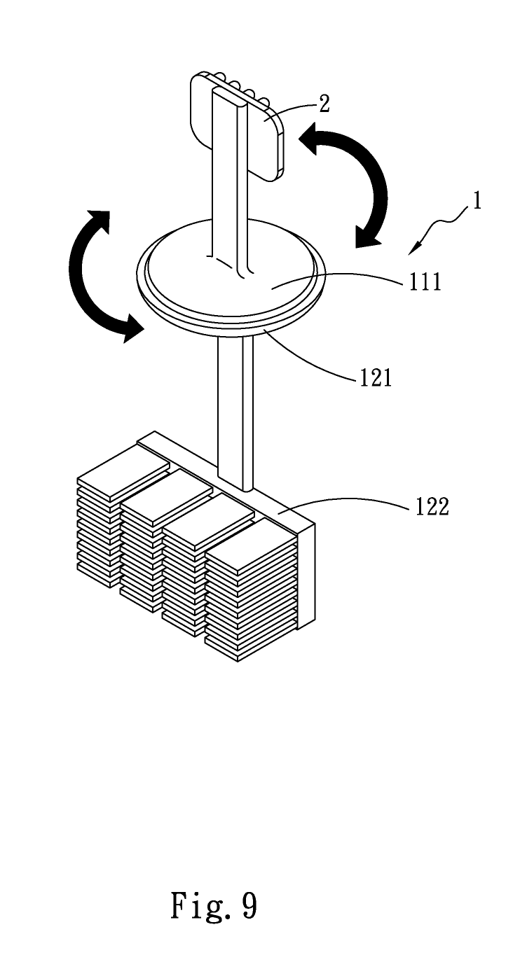

Please refer to FIG. 9 that illustrates how the rotatable heat dissipating device 1 of the present invention works. As shown, when it is desired to connect the rotatable heat dissipating device 1 to the heat-producing unit 2, and the heat-producing unit 2 is oriented toward a direction different from an orientation to which the rotatable heat dissipating device 1 can be installed, a user can simply rotate the main body 111 relative to the base 121 for the heat absorbing end 113 or the first heat transfer end 1121 to face toward and connect to the heat-producing unit 2.

On the other hand, in the event the heat radiating section 122 of the rotatable heat dissipating device 1 is not located at an optimal angular position for radiating heat, the user can also easily rotate the base 121 relative to the main body 111 to upgrade the heat dissipation efficiency of the heat radiating section 122.

What is claimed is:

1. A rotatable heat dissipating device, comprising:
a heat-transfer element including a flat main body and a heat transfer section extended from one face of the main body; and
a heat-dissipation element including a base, a heat radiating section, and a connecting section; the base being provided on one face oriented toward the main body with a recess for rotatably receiving the main body therein; and
the connecting section being extended from one face of the base opposite to the recess to connect with the heat radiating section.

2. The rotatable heat dissipating device as claimed in claim 1, wherein the heat radiating section includes a plurality of radiating fins, and the radiating fins are selected from the group consisting of pin fins and straight fins.

3. The rotatable heat dissipating device as claimed in claim 1, wherein the heat-transfer element further includes a heat absorbing end provided at an end of the heat transfer section opposite to the main body for connecting to at least one heat-producing unit.

4. The rotatable heat dissipating device as claimed in claim 3, wherein a heat conducting medium is applied between the heat absorbing end and the heat-producing unit.

5. The rotatable heat dissipating device as claimed in claim 1, wherein a heat conducting medium is applied between the main body and the recess.

6. The rotatable heat dissipating device as claimed in claim 4, wherein the heat conducting medium is selected from the group consisting of a solder paste and a thermal paste.

7. The rotatable heat dissipating device as claimed in claim 5, wherein the heat conducting medium is selected from the group consisting of a solder paste and a thermal paste.

8. The rotatable heat dissipating device as claimed in claim 3, wherein the heat-producing unit is an LED module.

9. The rotatable heat dissipating device as claimed in claim 4, wherein the heat-producing unit is an LED module.

10. The rotatable heat dissipating device as claimed in claim 1, wherein the heat transfer section is a heat pipe; the heat pipe having at least one first heat transfer end and at least one second heat transfer end; the first heat transfer

11. The rotatable heat dissipating device as claimed in claim 10, wherein the connecting section is a heat pipe; the heat pipe having at least one third heat transfer end and at least one fourth heat transfer end; the third heat transfer end being connected to the base, and the fourth heat transfer end being connected to the heat radiating section.

12. The rotatable heat dissipating device as claimed in claim 1, wherein the main body has a shape selected from the group consisting of a round shape and a semicircular shape.

13. The rotatable heat dissipating device as claimed in claim 1, wherein the recess is a round recess.
